(19) United States
(12) Patent Application Publication
(10) Pub. No.: US 2015/0226487 A1
(43) Pub. Date: Aug. 13, 2015

(54) SUBSTRATE HEATING DEVICE AND METHOD

(71) Applicant: SHENZHEN CHINA STAR OPTOELECTRONICS TECHNOLOGY CO., LTD., Shenzhen, Guangdong (CN)

(72) Inventor: Shijian Qin, Shenzhen (CN)

(21) Appl. No.: 14/235,797

(22) PCT Filed: Jan. 13, 2014
(86) PCT No.: PCT/CN2014/070503

§ 371 Date: Jan. 29, 2014

(30) Foreign Application Priority Data
Dec. 31, 2013 (CN) 201310752561.2

(51) Int. Cl. F27D 19/00; F27D 11/02; F27D 11/12; F27D 5/00

(52) U.S. Cl. CPC F27D 19/00; F27D 5/0037; F27D 11/02; F27D 11/12; F27D 2019/0003; F27D 21/0014

(57) ABSTRACT

The present disclosure provides a substrate heating device, including a heating furnace, a platform arranged in the heating furnace with a to-be-heated substrate placed thereon, a plurality of spaced heaters arranged on the substrate for heating the substrate, a plurality of reflectors respectively arranged above the heaters, and a plurality of rotation controllers arranged on an inner side of the heating furnace for controlling rotations of the reflectors. With the present disclosure, the temperature of the substrate can be uniform to achieve accurate control of the uniformity of the temperature of the substrate.

### BACKGROUND

1. Technical Field

The present disclosure generally relates to technologies of liquid displays, and more particularly, to a substrate heating device and a substrate heating method.

2. Description of Related Art

At present, when heating a substrate by a high-temperature furnace, heaters arranged at different regions inside the furnace are used for heating different heated points of the substrate. A power of each heater is independently controlled to adjust an uniformity of the heating temperature of the substrate to ensure that the temperatures of different regions of the substrate are uniform. Although using the heaters to control the uniformity of the temperature of the substrate can make the temperatures of different regions of the substrate be substantially uniform, accurate control of the uniformity of the temperature of the substrate cannot be achieved in this way.

### SUMMARY

The main object of the present disclosure is to provide a substrate heating device and a substrate heating method, for accurately controlling a temperature uniformity of the substrate and enabling the temperatures of different regions of the substrate to be uniform.

The substrate heating device provided in the present disclosure includes a heating furnace, a platform arranged in the heating furnace with a to-be-heated substrate placed thereon, a plurality of spaced heaters arranged on the substrate for heating the substrate, a plurality of reflectors respectively arranged above the heaters, and a plurality of rotation controllers arranged on an inner side of the heating furnace for controlling rotations of the reflectors.

Preferably, the substrate further includes a plurality of temperature measurement controllers arranged on an outer side of the heating furnace for measuring temperatures of heated points of the heaters on the substrate, and the temperature measurement controllers are connected to the substrate via temperature measurement lines.

Preferably, each rotation controller is connected to the corresponding temperature measurement controller via a rotation control line for controlling a rotation angle of the corresponding reflector according to a control signal outputted from the corresponding temperature measurement controller.

Preferably, the heaters are evenly-spaced from each other.

Preferably, support legs are arranged on the platform for positioning the substrate in a heating range of the heaters.

Preferably, the substrate heating device further includes a plurality of temperature measurement controllers for measuring temperatures of heated points of the heaters on the substrate, and the temperature measurement controllers are connected to the substrate via temperature measurement lines.

Preferably, each rotation controller is connected to the corresponding temperature measurement controller via a rotation control line for controlling a rotation angle of the corresponding reflector according to a control signal outputted from the corresponding temperature measurement controller.

Preferably, the heaters are evenly-spaced from each other.

The substrate heating method provided in the present disclosure includes steps of:

heating a substrate placed on a platform by a plurality of heaters;

measuring temperatures of heated points of the heaters on the substrate by a plurality of temperature measurement controllers, obtaining a temperature uniformity of the substrate according to the temperatures, generating a control signal according to the temperature uniformity and outputting the control signal to a corresponding rotation controller; and

the rotation controller controlling a corresponding reflector to rotate over a predetermined angle according to the control signal for adjusting the temperature uniformity of the substrate.

Preferably, the step of measuring temperatures of heated points of the heaters on the substrate by a plurality of temperature measurement controllers, obtaining a temperature uniformity of the substrate according to the temperatures, generating a control signal according to the temperature uniformity and outputting the control signal to a corresponding rotation controller includes:

the temperature measurement controllers measuring the temperatures of the heated points of the heaters on the substrate via temperature measurement lines and converting the temperatures to electrical signals;

outputting the converted temperatures and calculating the temperature uniformity of the substrate according to the temperatures of the heated points, generating the control signal for controlling the rotation of the corresponding reflector according to the temperature uniformity; and

outputting the generated control signal to the corresponding rotation controller via a rotation control line.

Preferably, the method further includes the following step after the step of the rotation controller controlling a corresponding reflector to rotate over a predetermined angle according to the control signal:

the corresponding reflector rotating over a predetermined angle under the control of the corresponding rotation controller to reflect heat above the corresponding heater to a corresponding position on the substrate, thereby adjusting the temperature uniformity of the substrate.

Preferably, the method further includes the following step before the step of heating a substrate placed on a platform by a plurality of heaters:

placing the substrate on the platform and positioning the substrate in a heating range of the heaters via support legs arranged on the platform.

Preferably, the method further includes the following step after the step of the rotation controller controlling a corresponding reflector to rotate over a predetermined angle according to the control signal:

the corresponding reflector rotating over a predetermined angle under the control of the corresponding rotation controller to reflect heat above the corresponding heater to a corresponding position on the substrate, thereby adjusting the temperature uniformity of the substrate.

Preferably, the method further includes the following step before the step of heating a substrate placed on a platform by a plurality of heaters:

placing the substrate on the platform and positioning the substrate in a heating range of the heaters via support legs arranged on the platform.

Preferably, the method further includes the following step before the step of heating a substrate placed on a platform by a plurality of heaters:

placing the substrate on the platform and positioning the substrate in a heating range of the heaters via support legs arranged on the platform.

By securing the reflectors above the heaters for reflecting the heat generated above the heaters to the corresponding positions on the substrate, and securing the rotation controllers on the inner side of the heating furnace for controlling the rotations of the reflectors, after the temperatures of the heated points of the heaters on the substrate are measured, the temperature uniformity of the substrate can be calculated. Each temperature measurement controller generates the corresponding control signal and outputs the control signal to the corresponding rotation controller according to the temperature uniformity, thus, the rotation controller controls the rotation angle of the corresponding reflector according to the control signal, allowing the temperature of the substrate to be uniform and realizing the accurate control of the uniformity of the temperature of the substrate.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of a substrate heating device in accordance with an embodiment of the present disclosure;

FIG. 2 is a flow chart of a substrate heating method in accordance with an embodiment of the present disclosure;

FIG. 3 is a flow chart of a step that a temperature measurement controller outputs a control signal to a rotation controller;

FIG. 4 is a flow chart of a substrate heating method in accordance with a second embodiment of the present disclosure; and

FIG. 5 is a flow chart of a substrate heating method in accordance with a third embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

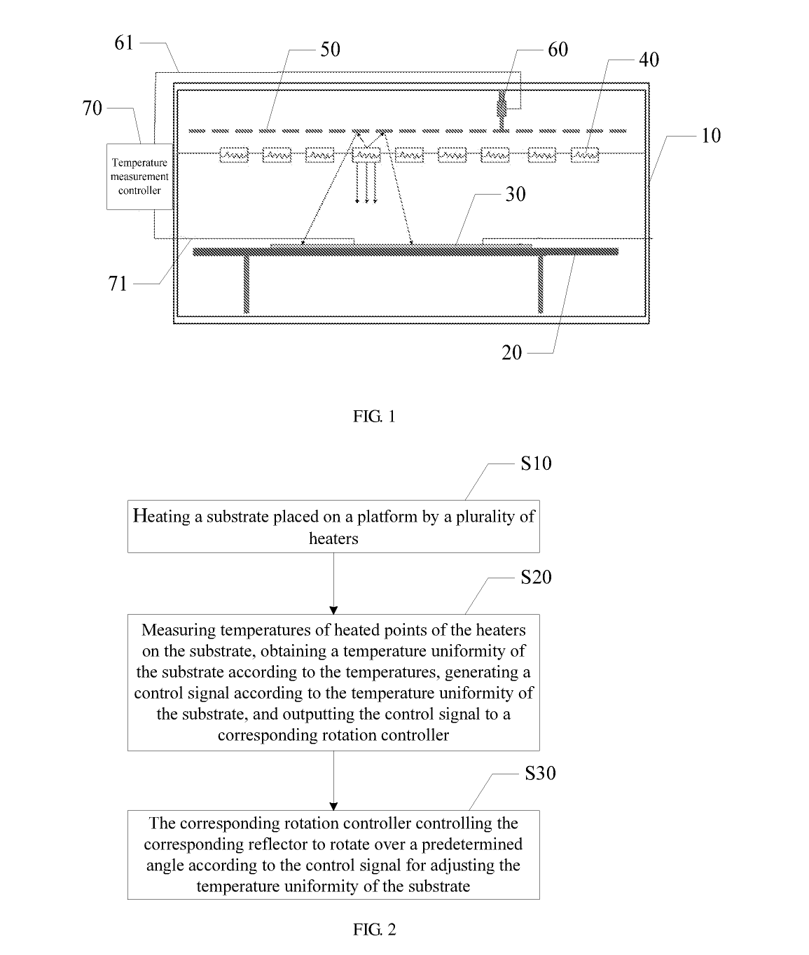

The present disclosure provides a substrate heating device. Referring to FIG. 1, which is a schematic view of the substrate heating device in accordance with an embodiment of the present disclosure, the substrate heating device includes a heating furnace 10, a platform 20, a to-be-heated substrate 30, and a plurality of heaters 40. The platform 20 and the substrate 30 are placed in the heating furnace 10 with the substrate 30 being placed on the heating platform 20. The heaters 40 are spacedly arranged in the heating furnace 10 and are located above the substrate 30 for heating the substrate 30. On the basis of ensuring that a heating range of the heaters 40 can cover the whole surface of the substrate 30, the heaters 40 can be evenly-spaced or unevenly-spaced according to actual requirements. In the embodiment, the platform 20 is provided with support legs (not shown) for positioning the substrate 30 after the substrate 30 is placed on the platform 20, that is, for securing the substrate 30 in the heating range of the heaters 40. In the embodiment, the substrate heating device further includes a plurality of reflectors 50 and a plurality of rotation controllers 60. The number of the reflectors 50 corresponds to that of the heaters 40. The reflectors 50 are respectively secured above the heaters 40 for reflecting heat above the corresponding heaters 40 to corresponding positions on the substrate 30. The rotation controllers 60 are secured on an inner side of the heating furnace 10 for controlling rotations of the reflectors 50.

In the embodiment, the substrate heating device further includes a plurality of temperature measurement controllers 70. The number of the temperature measurement controllers 70 corresponds to that of the heaters 40. The temperature measurement controllers 70 are arranged on an outer side of the heating furnace 10 and are respectively connected to heated points of the heaters 40 on the substrate 30 via temperature measurement lines 71. Each temperature measurement controller 70 is configured for measuring the temperature of a respective heated point of the corresponding heater 40 on the substrate 30 and generating a control signal and outputting the control signal to the corresponding rotation controller 60 according to a calculated temperature uniformity. The control signal is used for indicating a rotation angle of the corresponding reflector 50. Each rotation controller 60 is connected to the corresponding rotation controller 70 via a rotation control line 61 and controls the rotation angle of the corresponding reflector 50 according to the received control signal outputted from the corresponding temperature measurement controller 70.

When heating the substrate 30 placed on the platform 20, the heaters 40 arranged above the substrate 30 heat the substrate 30, and the temperature measurement controllers 70 respectively measure the temperatures of the heated points on the substrate 30 via the connections between the temperature measurement lines 71 and the substrate 30. The temperature measurement controllers 70 output the measured temperatures to a calculation device such that the calculation device can calculate the temperature uniformity of the substrate 30 according to the received temperatures. The calculation device outputs a calculation result to each temperature measurement controller 70 after the temperature uniformity is obtained. Each temperature measurement controller 70 generates the control signal for controlling the corresponding rotation controller 60 and outputs the control signal to the corresponding rotation controller 60, allowing each rotation controller 60 to control the rotation angle of the corresponding reflector 50 according to the control signal. In this way, each reflector 50 can reflect the heat above the corresponding heater 40, complementarily heat a position on the substrate having a relatively lower temperature and enabling the temperature of the substrate to be more uniform.

By securing the reflectors 50 above the heaters 40 for reflecting the heat above the heaters 40 to the corresponding positions on the substrate 30, and securing the rotation controllers 60 on the inner side of the heating furnace 10 for controlling the rotations of the reflectors 50, after the temperatures of the heated points of the heaters 40 on the substrate 30 are measured, the temperature uniformity of the substrate 30 can be calculated. The corresponding temperature measurement controller 70 generates the control signal and outputs the control signal to the corresponding rotation controller 60 according to the temperature uniformity, thus, the rotation controller 60 controls the rotation angle of the corresponding reflector 50 according to the control signal, allowing the temperature of the substrate 30 to be uniform and realizing the accurate control of the uniformity of the temperature of the substrate 30.

The present disclosure further provides a substrate heating method which can be applied to the above substrate heating device.

Referring to FIG. 2, which is a flow chart of the substrate heating method in accordance with a first embodiment of the present disclosure, the method includes the following steps.

Step S10, heating a substrate placed on a platform by a plurality of heaters.

When heating the substrate 30 placed on the platform, the heaters 40 arranged above the substrate 30 heat the substrate 30. In the embodiment, the heaters 40 are spacedly arranged and are located above the substrate 30 for heating the substrate 30. On the basis of ensuring that the heating range of the heaters 40 can cover the whole surface of the substrate 30, the heaters 40 can be evenly-spaced or unevenly-spaced according to actual requirements.

Step S20, measuring temperatures of heated points of the heaters on the substrate, obtaining a temperature uniformity of the substrate according to the temperatures, generating a control signal according to the temperature uniformity of the substrate, and outputting the control signal to a corresponding rotation controller.

In the process of heating the substrate 30 by the heaters 40, each temperature measurement controller 70 measures the temperature of a respective heated point of the substrate, generates the control signal which is used for controlling the corresponding rotation controller 60 according to the calculated temperature uniformity, and outputs the control signal to the corresponding rotation controller 60 such that the rotation controller 60 can control the rotation of the corresponding reflector 50. In the embodiment, the number of the temperature measurement controllers 70 corresponds to that of the heater, and the temperature measurement controllers 70 are arranged on outer side of the heating furnace 10 and are respectively connected to the heated points of the heaters 40 on the substrate 30 via temperature measurement lines 71.

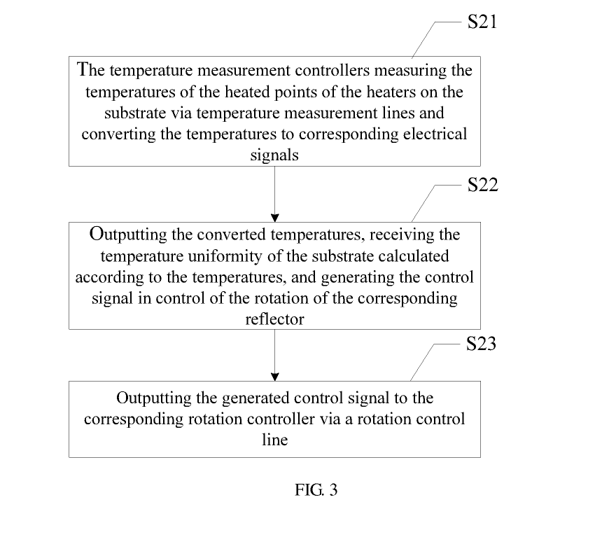

Referring to FIG. 3 together, which is a flow chart of a step that the temperature measurement controller outputs the control signal to the corresponding rotation controller, in the embodiment, the step S20 specifically includes the following steps.

Step S21, the temperature measurement controllers measuring the temperatures of the heated points of the heaters on the substrate via temperature measurement lines and converting the temperatures to corresponding electrical signals.

The temperature measurement controllers 70 measure the temperatures of the heated points of the substrate, convert the temperatures to the electrical signals, and output the temperatures in the forms of electrical signals to a calculation device for calculating the temperature uniformity of the substrate 30. In the embodiment, the calculation device can be a computer or a calculator which is connected to the temperature measurement lines 70.

Step S22, outputting the converted temperatures, receiving the temperature uniformity of the substrate calculated according to the temperatures, and generating the control signal in control of the rotation of the corresponding reflector.

Step S23, outputting the generated control signal to the corresponding rotation controller via a rotation control line.

The temperature measurement controllers 70 output the electrical signals converted from the temperatures to the calculation device, and the calculation device calculates the temperature uniformity of the substrate 30 according to the temperatures. After the calculation device calculates the temperature uniformity, the calculation device outputs the calculation result to the corresponding temperature measurement controller 70. After receiving the temperature uniformity of the substrate 30, the temperature measurement controller 70 generates the control signal in control of the rotation of the corresponding reflector 50, and outputs the generated control signal to the corresponding rotation controller 60 via the rotation control line 61 for controlling the corresponding reflector 50 to rotate over a predetermined angle.

Step S30, the corresponding rotation controller controlling the corresponding reflector to rotate over a predetermined angle according to the control signal for adjusting the temperature uniformity of the substrate.

After receiving the control signal outputted from the corresponding temperature measurement controller 70, the rotation controller 60 controls the rotation angle of the corresponding reflector 50 such that the reflector 50 can reflect the heat above the corresponding heater 40, complementarily heating a position on the substrate having a relatively lower temperature and making the temperature of the substrate be more uniform.

By securing the reflectors 50 above the heaters 40 for reflecting the heat generated above the heaters 40 to the corresponding positions on the substrate 30, and securing the rotation controllers 60 on the inner side of the heating furnace 10 for controlling the rotations of the reflectors 50, after the temperatures of the heated points of the heaters on the substrate are measured, the temperature uniformity of the substrate 30 can be calculated. The corresponding temperature measurement controller 70 generates the corresponding control signal and outputs the control signal to the corresponding rotation controller 60 according to the temperature uniformity, thus, the rotation controller 60 controls the rotation angle of the corresponding reflector 50 according to the control signal, allowing the temperature of the substrate 30 to be uniform and realizing the accurate control of the uniformity of the temperature of the substrate 30.

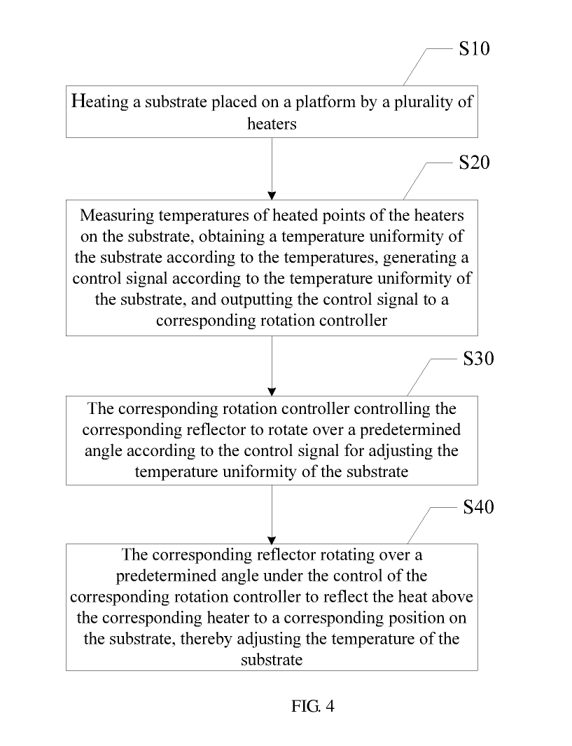

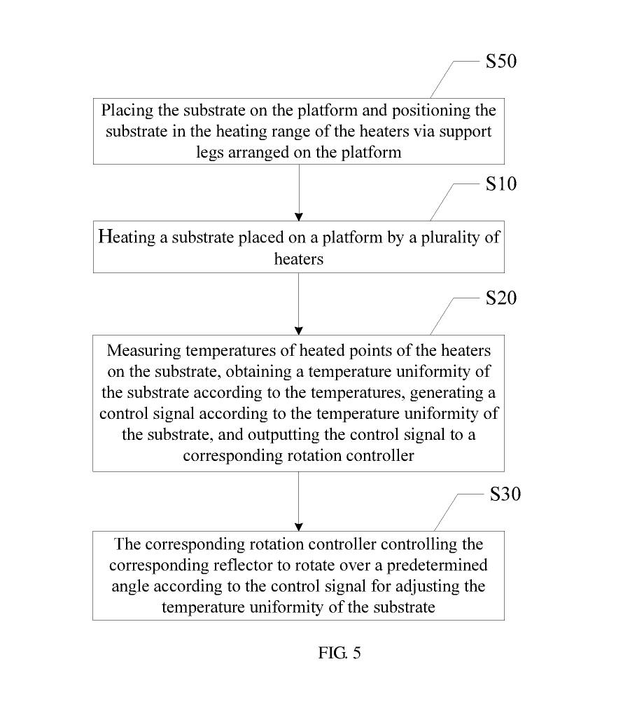

Referring to FIG. 4, which is a flow chart of a substrate heating method in accordance with a second embodiment of the present disclosure, based on the first embodiment, the method can further include the following steps after the step S30.

Step S40, the corresponding reflector rotating over a predetermined angle under the control of the corresponding rotation controller to reflect the heat above the corresponding heater to a corresponding position on the substrate, thereby adjusting the temperature of the substrate.

In the embodiment, after receiving the control signal outputted from the corresponding temperature measurement controller 70, the rotation controller 60 controls the corresponding reflector 50 according to the control signal. The reflector 50 rotates over a predetermined angle under the control of the rotation controller 60 to reflect the heat above the heater 40 to the position requiring for temperature complement on the substrate, enabling the temperature of the substrate 30 to be more uniform and adjusting the temperature uniformity of the substrate 30.

Referring to FIG. 5, which is a flow chart of a substrate heating method in accordance with a third embodiment of the present disclosure, based on the first embodiment, the method of the third embodiment further includes the following step before the step S10.

Step S50, placing the substrate on the platform and positioning the substrate in the heating range of the heaters via support legs arranged on the platform.

In the embodiment, before the substrate is heated, the substrate 30 is at first placed on the substrate and is positioned via the support legs arranged on the platform 20, that is, the substrate 30 is positioned in the heating range of the heaters 40.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A substrate heating device, comprising:
a heating furnace;
a platform arranged in the heating furnace with a to-be-heated substrate placed thereon;
a plurality of spaced heaters arranged on the substrate for heating the substrate;
a plurality of reflectors respectively arranged above the heaters; and
a plurality of rotation controllers arranged on an inner side of the heating furnace for controlling rotations of the reflectors.

2. The substrate of claim 1 further comprising a plurality of temperature measurement controllers arranged on an outer side of the heating furnace for measuring temperatures of heated points of the heaters on the substrate, and the temperature measurement controllers are connected to the substrate via temperature measurement lines.

3. The substrate of claim 2, wherein each rotation controller is connected to the corresponding temperature measurement controller via a rotation control line for controlling a rotation angle of the corresponding reflector according to a control signal outputted from the corresponding temperature measurement controller.

4. The substrate of claim 3, wherein the heaters are evenly-spaced from each other.

5. The substrate of claim 1, wherein support legs are arranged on the platform for positioning the substrate in a heating range of the heaters.

6. The substrate heating device of claim 5 further comprising a plurality of temperature measurement controllers for measuring temperatures of heated points of the heaters on the substrate, and the temperature measurement controllers are connected to the substrate via temperature measurement lines.

7. The substrate hating device of claim 6, wherein each rotation controller is connected to the corresponding temperature measurement controller via a rotation control line for controlling a rotation angle of the corresponding reflector according to a control signal outputted from the corresponding temperature measurement controller.

8. The substrate heating device of claim 7, wherein the heaters are evenly-spaced from each other.

9. A substrate heating method, comprising:
heating a substrate placed on a platform by a plurality of heaters;
measuring temperatures of heated points of the heaters on the substrate by a plurality of temperature measurement controllers, obtaining a temperature uniformity of the substrate according to the temperatures, generating a control signal according to the temperature uniformity and outputting the control signal to a corresponding rotation controller; and
the rotation controller controlling a corresponding reflector to rotate over a predetermined angle according to the control signal for adjusting the temperature uniformity of the substrate.

10. The method of claim 9, wherein the step of measuring temperatures of heated points of the heaters on the substrate by a plurality of temperature measurement controllers, obtaining a temperature uniformity of the substrate according to the temperatures, generating a control signal according to the temperature uniformity and outputting the control signal to a corresponding rotation controller comprises:
the temperature measurement controllers measuring the temperatures of the heated points of the heaters on the substrate via temperature measurement lines and converting the temperatures to electrical signals;
outputting the converted temperatures and calculating the temperature uniformity of the substrate according to the temperatures of the heated points, generating the control signal for controlling the rotation of the corresponding reflector according to the temperature uniformity; and
outputting the generated control signal to the corresponding rotation controller via a rotation control line.

11. The method of claim 9 further comprising the following step after the step of the rotation controller controlling a corresponding reflector to rotate over a predetermined angle according to the control signal:
the corresponding reflector rotating over a predetermined angle under the control of the corresponding rotation controller to reflect heat above the corresponding heater to a corresponding position on the substrate, thereby adjusting the temperature uniformity of the substrate.

12. The method of claim 11 further comprising the following step before the step of heating a substrate placed on a platform by a plurality of heaters:
placing the substrate on the platform and positioning the substrate in a heating range of the heaters via support legs arranged on the platform.

13. The method of claim 9 further comprising the following step after the step of the rotation controller controlling a corresponding reflector to rotate over a predetermined angle according to the control signal:
the corresponding reflector rotating over a predetermined angle under the control of the corresponding rotation controller to reflect heat above the corresponding heater to a corresponding position on the substrate, thereby adjusting the temperature uniformity of the substrate.

14. The method of claim 13 further comprising the following step before the step of heating a substrate placed on a platform by a plurality of heaters:
placing the substrate on the platform and positioning the substrate in a heating range of the heaters via support legs arranged on the platform.

15. The method of claim 9 further comprising the following step before the step of heating a substrate placed on a platform by a plurality of heaters:
placing the substrate on the platform and positioning the substrate in a heating range of the heaters via support legs arranged on the platform.
